(19) United States
(12) Patent Application Publication
(10) Pub. No.: US 2017/0174877 A1
(43) Pub. Date: Jun. 22, 2017

(54) COMPATIBILIZER AND THERMOPLASTIC RESIN EMPLOYING THE SAME

(71) Applicant: INDUSTRIAL TECHNOLOGY RESEARCH INSTITUTE, Hsinchu County (TW)

(72) Inventors: Yao-Chu CHUNG, Pingtung City (TW); Wen-Faa KUO, Hsinchu City (TW); Chun-Ming TING, New Taipei City (TW); Chien-Ming CHEN, Taoyuan City (TW); Tien-Jung HUANG, Hsinchu County (TW)

(73) Assignee: INDUSTRIAL TECHNOLOGY RESEARCH INSTITUTE, Hsinchu County (TW)

(21) Appl. No.: 15/085,694

(22) Filed: Mar. 30, 2016

(30) Foreign Application Priority Data
Dec. 18, 2015 (TW) 104142633

(51) Int. Cl. C08L 23/14; C08L 9/00

(52) U.S. Cl. CPC C08L 23/147; C08L 9/00; C08L 2207/04; C08L 2205/08; C08L 2205/025; C08L 2205/035

(57) ABSTRACT

A compatibilizer and thermoplastic resin employing the same are provided. The compatibilizer includes about 100 parts by weight of polyolefin having at least one reactive functional group, and about 80-120 parts by weight of a copolymer, wherein the copolymer has x number of repeat units represented by

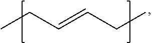

y number of repeat units represented by

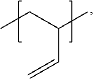

z number of repeat units represented by

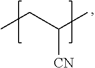

and at least one terminal group represented by

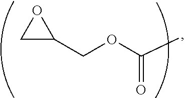

x, y, and z are independent and can be an integer larger than or equal to 1; and x/(x+y+z) is from about 0.5 to 0.7, y/(x+y+z) is from about 0.1 to 0.2, and z/(x+y+z) is from about 0.1 and 0.4.

### CROSS REFERENCE TO RELATED APPLICATIONS

The application is based on, and claims priority from, Taiwan Application Serial Number 104142633, filed on Dec. 18, 2015, the disclosure of which is hereby incorporated by reference herein in its entirety.

### TECHNICAL FIELD

The technical field relates to a compatibilizer and a thermoplastic resin employing the same.

### BACKGROUND

Polymer blends are known and used widely in various applications. Polymer blends are commonly used to combine, in a single material, the properties of two different polymers. However, due to immiscibility, a phase separation is often observed in the blending of two different polymers, and it is often difficult to obtain a blend morphology conducive to useful mechanical properties.

Therefore, there is a need to solve the low compatibility problem of two essentially immiscible polymers.

### SUMMARY

The disclosure provides a compatibilizer that can include about 100 parts by weight of polyolefin having at least one reactive functional group; and about 80-120 parts by weight of a copolymer. In particular, the copolymer can have x number of repeat units represented by

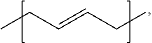

y number of repeat units represented by

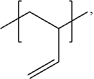

z number of repeat units represented by

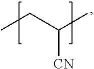

and at least one terminal group represented by

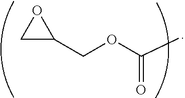

In particular, x y, and z can be independently an integer larger than or equal to 1; and x/(x+y+z) can be from about 0.5 to 0.7, y/(x+y+z) can be from about 0.1 to 0.2, and z/(x+y+z) can be from about 0.1 to 0.4. In addition, the repeat unit represented by

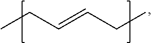

the repeat unit represented by

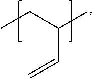

and the repeat unit represented by

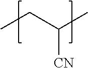

can be arranged in a regular or random fashion.

According to another embodiment of the disclosure, the disclosure provides a thermoplastic resin composition. The thermoplastic resin composition includes: (a) about 60-90 parts by weight of nitrile-butadiene rubber; (b) about 10-40 parts by weight of polyolefin; (c) the aforementioned compatibilizer, wherein the compatibilizer can have a weight percentage from about 5 wt % to about 15 wt %, based on the total weight of (a) nitrile-butadiene rubber and (b) polyolefin; and (d) cross-linking agent, wherein the cross-linking agent has a weight percentage from about 0.2 wt % to about 2.0 wt %, based on the total weight of (a) nitrile-butadiene rubber and (b) polyolefin.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is AFM (atomic force microscopy) image of the product of the thermoplastic resin composition of Example 2.

FIG. 2 is AFM (atomic force microscopy) image of the product of the thermoplastic resin composition of Comparative Example 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

According to an embodiment of the disclosure, the disclosure provides a compatibilizer, and a thermoplastic resin composition employing the same. The compatibilizer of the disclosure can enhance the compatibility of the mixture including polyolefin (such as polypropylene (PP) and nitrile-butadiene rubber (NBR), resulting in the increase of the mechanical strength (such as tensile strength, tensile elongation, and tear strength) of the thermoplastic resin composition. Therefore, the compatibilizer of the disclosure can be widely applied in the automotive and construction fields, as well as in optoelectronic devices, medical equipment, and daily necessities.

The compatibilizer of the disclosure can include about 100 parts by weight of polyolefin having at least one reactive functional group; and about 80-120 parts by weight of a copolymer. Furthermore, according to embodiments of the disclosure, the compatibilizer of the disclosure can be a reaction product of about 100 parts by weight of polyolefin having at least one reactive functional group; and about 80-120 parts by weight of a copolymer. The copolymer can have x number of repeat units represented by

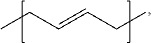

y number of repeat units represented by

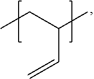

z number of repeat units represented by

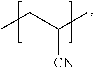

and at least one terminal group represented by

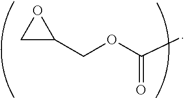

For example, the copolymer can have structure represented by Formula (I)

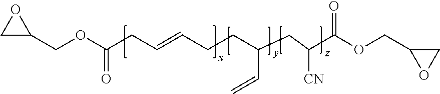

### Formula (I)

In particular, x y, and z can be independently an integer larger than or equal to 1; and x/(x+y+z) can be from about 0.5 to about 0.7, y/(x+y+z) can be from about 0.1 to about 0.2, and z/(x+y+z) can be from about 0.1 to about 0.4. In addition, the repeat unit represented by

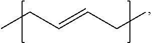

the repeat unit represented by

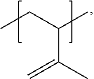

and the repeat unit represented by

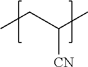

can be arranged in a regular or random fashion. the polyolefin having at least one reactive functional group can be polypropylene having at least one reactive functional group, ethylene-propylene-diene copolymer (EPDM) having at least one reactive functional group, or a combination thereof. The reactive functional group can be

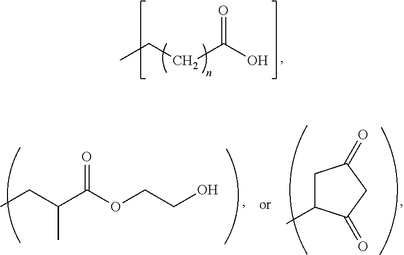

wherein n is an integer from 1 to 10. When the amount of the copolymer in the compatibilizer of the disclosure is too low (i.e. the copolymer is in an amount of less than about 80 parts by weight), the product of the thermoplastic resin composition employing the compatibilizer has inferior physical properties due to the poor dispersibility of the copolymer. On the other hand, when the amount of the copolymer in the compatibilizer of the disclosure is too high (i.e. the copolymer is in an amount of more than about 120 parts by weight), the product of the thermoplastic resin composition employing the compatibilizer has inferior mechanical strength.

According to an embodiment of the disclosure, the polyolefin having at least one reactive functional group (such as polypropylene having at least one reactive functional group, ethylene-propylene-diene copolymer (EPDM) having at least one reactive functional group, or a combination thereof) can have a melt index (MI) from about 0.5 g/10 min to about 100 g/10 min (measured at 230° C., 2.16 kg).

According to an embodiment of the disclosure, the polypropylene having at least one reactive functional group can include at least a repeat unit represented by

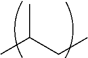

and a repeat unit represented by

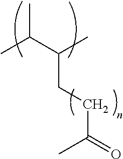

(wherein n is an integer from 1 to 10). In addition, the polypropylene having at least one reactive functional group can include at least a repeat unit represented by

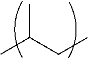

and a repeat unit represented by

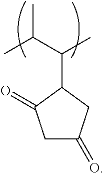

Moreover, according to embodiments of the disclosure, the polypropylene having at least one reactive functional group can include at least a repeat unit represented by

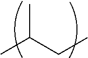

and a repeat unit represented by

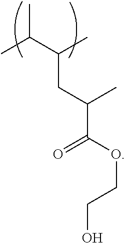

According to an embodiment of the disclosure, the ethylene-propylene-diene copolymer (EPDM) having at least one reactive functional group can include a repeat unit represented by

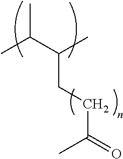

(wherein n is an integer from 1 to 10), a repeat unit represented by

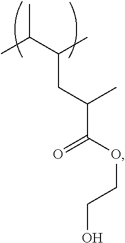

a repeat unit represented by

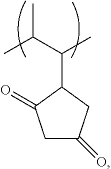

a repeat unit represented by

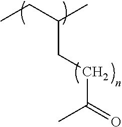

(wherein n is an integer from 1 to 10), a repeat unit represented by

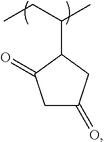

and/or a repeat unit represented by

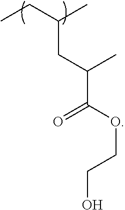

In addition, the reactive functional group of the polyolefin having at least one reactive functional group (such as the polypropylene having at least one reactive functional group, the ethylene-propylene-diene copolymer (EPDM) having at least one reactive functional group, or a combination thereof) can have a weight percentage from about 0.5 wt % to about 5 wt %, based on the weight of the polyolefin having at least one reactive functional group. When the weight percentage of the reactive functional group of the polyolefin having at least one reactive functional group is too low, the compatibility is inferior and the product of the thermoplastic resin composition employing the compatibilizer has inferior physical properties due to the poor dispersibility of the polyolefin having at least one reactive functional group. On the other hand, when the weight percentage of the reactive functional group of the polyolefin having at least one reactive functional group is too high, the compatibilizer is apt to lose its resistance to oil.

According to other embodiments of the disclosure, the copolymer of the disclosure (such as the copolymer represented by Formula (I)) can have a weight average molecular weight from about 1,000 to about 10,000. When the weight average molecular weight of the copolymer is too low, the product of the thermoplastic resin composition has inferior physical properties. On the other hand, when the weight average molecular weight of the copolymer is too high, the copolymer is apt not to react with the polyolefin having at least one reactive functional group (such as the polypropylene having at least one reactive functional group, the ethylene-propylene-diene copolymer (EPDM) having at least one reactive functional group, or a combination thereof) resulting from the decrease in amount of terminal groups. In addition, the ratio of the number of the terminal groups represented by

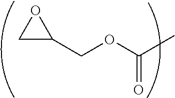

of the copolymer represented by Formula (I) and the sum of x, y, and z can be from about 0.008 to about 0.05. Namely, 2/(x+y+z) can be from about 0.008 to about 0.05. When the ratio of the number of the terminal groups represented by

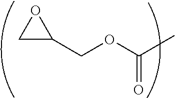

of the copolymer represented by Formula (I) and the sum of x, y, and z is too high or low, the thermoplastic resin composition employing the compatibilizer has low compatibility.

The disclosure also provides a thermoplastic resin composition (such as thermoplastic elastomer) including (a) about 60-90 parts by weight of nitrile-butadiene rubber; (b) about 10-40 parts by weight of polyolefin (such as polyethylene, polypropylene, polybutene, or a combination thereof); (c) the aforementioned compatibilizer (including polyolefin having at least one reactive functional group, and the copolymer represented by Formula (I)); and, (d) cross-linking agent, wherein the cross-linking agent can have a weight percentage from about 0.2 wt % to about 2.0 wt %, based on the total weight of (a) nitrile-butadiene rubber and (b) polyolefin. The compatibilizer can have a weight percentage from about 5 wt % to about 15 wt %, based on the total weight of (a) nitrile-butadiene rubber and (b) polyolefin. When the weight percentage of the compatibilizer is too low, the product of the thermoplastic resin composition has inferior physical properties due to the poor dispersibility of the nitrile-butadiene rubber. On the other hand, when the weight percentage of the compatibilizer is too high, the product of the thermoplastic resin composition has inferior mechanical strength.

According to an embodiment of the disclosure, the cross-linking agent can be peroxide cross-linking agent, such as benzoyl peroxide, 1,1-bis(tert-butylperoxy)cyclohexane, 2,5-bis(tert-butylperoxy)-2,5-dimethylcyclohexane, 2,5-bis(tert-butylperoxy)-2,5-dimethyl-3-cyclohexyne, bis(1-(tert-butylpeorxy)-1-methy-ethyl)benzene, tert-butyl hydroperoxide, tert-butyl peroxide, tert-butyl peroxybenzoate, cumene hydroperoxide, cyclohexanone peroxide, dicumyl peroxide, lauroyl peroxide, or a combination thereof.

According to an embodiment of the disclosure, the thermoplastic resin composition may further include (e) inorganic powder, (f) plasticizer, or other additives. In particular, the inorganic powder can have a weight percentage from about 1 wt % to about 20 wt %, based on the total weight of (a) nitrile-butadiene rubber and (b) polyolefin. Due to the addition of the inorganic powder, the product of the thermoplastic resin composition exhibits non-stick characteristics and the feeding difficulty of nitrile-butadiene rubber can be improved. According to embodiments of the disclosure, the inorganic powder can be kaolin, silicon oxide, aluminum oxide, titanium oxide, zirconium oxide, aluminum hydroxide, magnesium hydroxide, or a combination thereof. The plasticizer can have a weight percentage from about 1 wt % to about 40 wt %, based on the total weight of (a) nitrile-butadiene rubber and (b) polyolefin. The addition of the plasticizer is able to reduce the melt viscosity and increase the dispersibility of the nitrile-butadiene rubber, resulting in the decrease of hardness (shore A) of the product of the thermoplastic resin composition. According to embodiments of the disclosure, the plasticizer can be dibutyl phthalate (DBP), dioctyl phthalate (DOP), diisononyl phthalate (DINP), butyl benzyl phthalate, diisooctyl phthalate, dicyclohexyl phthalate (DCHP), dibutyl adipate, dioctyl adipate (DOA), dibutyl sebacate, polypropylene glycol dibenzoate, 2-ethylhexyl diphenyl phosphate, t-butylphenyl diphenyl phosphate, trioctyl trimellitate (TOTM), tri-2-ethylhexyl trimellitate, triisononyl trimellitate, isopropyl myristate, or a combination thereof.

According to some embodiments of the disclosure, the method for preparing the thermoplastic resin composition of the disclosure includes mixing (a) nitrile-butadiene rubber, (b) polyolefin, (c) the aforementioned compatibilizer (including polyolefin having at least one reactive functional group, and the copolymer represented by Formula (I)), (d) cross-linking agent, and/or additives (such as: (e) inorganic powder, (f) plasticizer, or other additives) to obtain a mixture, and then kneading the mixture via a melt-kneader. The addition order of the components for preparing the mixture can be not limited. Namely, the components can be mixed in the same time, or the components can be added sequentially. For example, the polypropylene, nitrile-butadiene rubber, and additives are added sequentially before adding the compatibilizer; and, the cross-linking agent is then added and the mixture is subjected to a kneading process. According to another embodiment of the disclosure, the nitrile-butadiene rubber and polypropylene are mixed first, and the compatibilizer, additives, and cross-linking agent are added sequentially. According to other embodiments of the disclosure, the compatibilizer, nitrile-butadiene rubber, and polypropylene are mixed first, and the then additives and cross-linking agent are added. According to still another embodiment of the disclosure, the compatibilizer and nitrile-butadiene rubber are mixed and kneaded to form resin pellets, and then the polypropylene, resin pellets, cross-linking agent, and additives are mixed and kneaded.

Below, exemplary embodiments will be described in detail so as to be easily realized by a person having ordinary knowledge in the art. The disclosure concept may be embodied in various forms without being limited to the exemplary embodiments set forth herein. Descriptions of well-known parts are omitted for clarity.

Preparation of Polypropylene with Reactive Functional Group

### PREPARATION EXAMPLE 1

1.98 kg of polypropylene (PP) resin pellets was fed into a biaxial screw extruder. Next, 0.02 kg of acrylic acid (AA) and 2 g of 2,5-Dimethyl-2,5-di(tert-butylperoxy)hexane (serving as peroxide radical initiator) were introduced into the biaxial screw extruder via a side feed. The feed inlet temperature of the biaxial screw extruder was at 200° C., discharge temperature was at 210° C., rotation rate was set at 200 rpm, and the residence time was about 1 minute. Finally, the product was cooled by water and cut to form pellets, obtaining polypropylene with acrylic acid derivative group (PP-AA) resin pellets, wherein the reactive functional group has a weight percentage of about 1 wt %.

### PREPARATION EXAMPLE 2

1.98 kg of polypropylene resin pellets (PP) was fed into a biaxial screw extruder. Next, 0.02 kg of maleic anhydride (MAH) and 2 g of 2,5-dimethyl-2,5-di(tert-butylperoxy)hexane (serving as peroxide radical initiator) were introduced into the biaxial screw extruder via a side feed. The feed inlet temperature of the biaxial screw extruder was at 200° C., discharge temperature was at 210° C., rotation rate was set at 200 rpm, and the residence time was about 1 minute. Finally, the product was cooled by water and cut to form pellets, obtaining polypropylene with maleic anhydride derivative group (PP-MAH) resin pellets, wherein the reactive functional group has a weight percentage of about 1 wt %.

Preparation of ethylene-propylene-diene copolymer (EPDM) with Reactive Functional Group

### PREPARATION EXAMPLE 3

1.98 kg of ethylene-propylene-diene copolymer (sold by KUMHO with a trade number of KEP2320) was fed into a biaxial screw extruder. Next, 0.02 kg maleic anhydride (MAH) and 2 g of 2,5-dimethyl-2,5-di(tert-butylperoxy)hexane (serving as peroxide radical initiator) were introduced into the biaxial screw extruder via a side feed. The feed inlet temperature of the biaxial screw extruder was at 200° C., discharge temperature was at 210° C., rotation rate was set at 200 rpm, and the residence time was about 1 minute. Finally, the product was cooled by water and cut to form pellets, obtaining ethylene-propylene-diene copolymer with maleic anhydride derivative group (EPDM-MAH) resin pellets, wherein the reactive functional group has a weight percentage of about 1 wt %.

Preparation of Copolymer Having a Structure Represent by Formula (I)

### PREPARATION EXAMPLE 4

Bisphenol A epoxy resin (E-51, with an epoxy value of 0.49-0.53), and carboxyl-terminated nitrile-butadiene rubber (CTBN) (18.99% of acrylonitrile, with a carboxyl value of 0.4423 mmol/g, with a viscosity of 500 mPa·s) were added into a reaction bottle, and the mixture was stirred and heated to 150° C. After reacting for 3 hours, nitrile-butadiene rubber with terminal epoxy group (NBR-EPOXY) was obtained, wherein the reactive functional group of NBR-EPOXY had a weight percentage of about 0.5 wt %, and the viscosity of NBR-EPDXY was about 500 k-800 k CPs. The synthesis pathway of the above reaction was as follows:

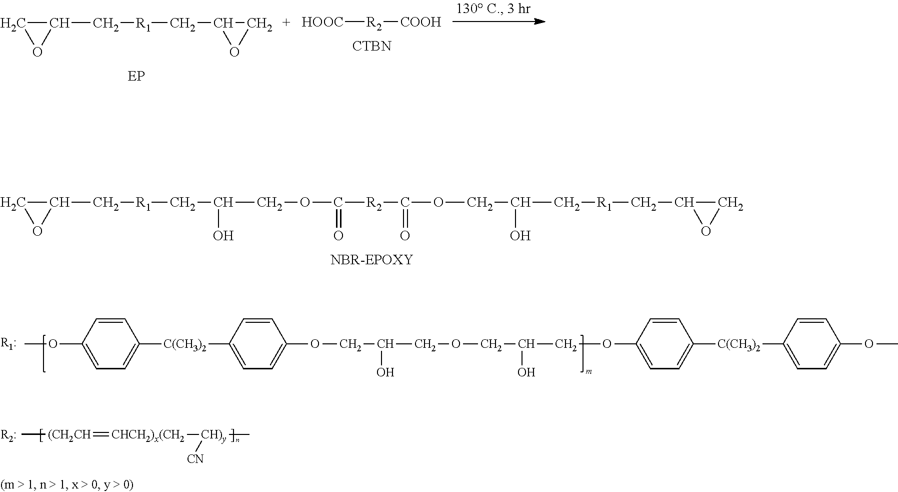

Preparation of Thermoplastic Resin Composition

### EXAMPLE 1

20 parts by weight of polypropylene (PP), 80 parts by weight of nitrile-butadiene rubber (NBR), 30 parts by weight of plasticizer (1,2,4-benzenetricarboxylicacid, TOTM), and 15 parts by weight of inorganic powder (kaolin) were kneaded by a melt-kneader (Brabender plasticoder) at 180° C. with a rotation rate of 100 rpm for 5 minutes. Next, 5 parts by weight of PP-MAH (prepared from Preparation Example 2) and 5 parts by weight of NBR-EPOXY (prepared from Preparation Example 4) were fed into the melt-kneader, and the mixture was kneaded for 6 minutes. Finally, 0.8 parts by weight of peroxide cross-linking agent (dibutyl adipate, DCP) was fed into the melt-kneader, and the mixture was kneaded for 8 minutes, obtaining the thermoplastic resin composition (1).

Next, a sheet with a thickness of 2 mm was formed via thermal compression molding of the thermoplastic resin composition (1) at 200° C. Next, the sheet was cut to test pieces for measuring the tensile strength, tensile elongation, tear strength by a multimeter according to ASTM D412 and ASTM D624. The results are shown in Table 1.

### EXAMPLE 2

Example 2 was performed in the same manner as in Example 1 except that PP-AA (prepared from Preparation Example 1) was substituted for PP-MAH, obtaining the thermoplastic resin composition (2). Next, a sheet with a thickness of 2 mm was formed via thermal compression molding of the thermoplastic resin composition (2) at 200° C. Next, the sheet was cut to test pieces for measuring the tensile strength, tensile elongation, tear strength by a multimeter according to ASTM D412 and ASTM D624. The results are shown in Table 1.

### EXAMPLE 3

Example 3 was performed in the same manner as in Example 1 except that EPDM-MAH (prepared from Preparation Example 3) was substituted for PP-MAH, obtaining the thermoplastic resin composition (3). Next, a sheet with a thickness of 2 mm was formed via thermal compression molding of the thermoplastic resin composition (3) at 200° C. Next, the sheet was cut to test pieces for measuring the tensile strength, tensile elongation, tear strength by a multimeter according to ASTM D412 and ASTM D624. The results are shown in Table 1.

### COMPARATIVE EXAMPLE 1

Comparative Example 1 was performed in the same manner as in Example except that no PP-MAH and NBR-EPOXY were present, obtaining the thermoplastic resin composition (4). Next, a sheet with a thickness of 2mm was formed via thermal compression molding of the thermoplastic resin composition (4) at 200° C. Next, the sheet was cut to test pieces for measuring the tensile strength, tensile elongation, tear strength by a multimeter according to ASTM D412 and ASTM D624. The results are shown in Table 1.

### COMPARATIVE EXAMPLE 2

Comparative Example 2 was performed in the same manner as in Example except that NBR-NH

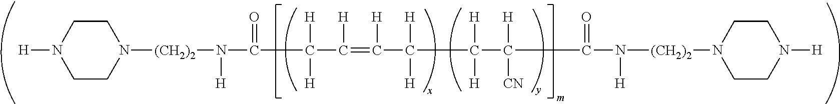

was substituted for NBR-EPOXY, obtaining the thermoplastic resin composition (5). Next, a sheet with a thickness of 2 mm was formed via thermal compression molding of the thermoplastic resin composition (5) at 200° C. Next, the sheet was cut to test pieces for measuring the tensile strength, tensile elongation, tear strength by a multimeter according to ASTM D412 and ASTM D624. The results are shown in Table 1.

TABLE 1

| | | | | | | commercial PP |
|---|---|---|---|---|---|---|
| | | | | | | and NBR |
| | | | | | | composition (sold |
| | | | | | | by AES Co. with a |
| | | | | Comparative | Comparative | trade number of |
| | Example 1 | Example 2 | Example 3 | Example 1 | Example 2 | Geolast 701-70) |
| PP-MAH (parts by | 5 | — | — | — | 5 | — |
| weight) | | | | | | |
| PP-AA (parts by | — | 5 | | — | — | — |
| weight) | | | | | | |
| EPDM-MAH (parts by | — | — | 5 | — | — | — |
| weight) | | | | | | |
| NBR-EPOXY (parts | 5 | 5 | 5 | — | — | — |
| by weight) | | | | | | |
| NBR-NH (parts by | — | — | — | — | 5 | — |
| weight) | | | | | | |
| tensile strength | 62 | 54 | 58 | 47 | 58 | 40 |
| (kg/cm²) | | | | | | |
| tensile elongation (%) | 166 | 241 | 284 | 184.7 | 155.3 | 174 |
| tear strength (kg/cm²) | 25 | 30 | 28 | 24 | 21 | 19 |

As shown in Table 1, since the thermoplastic resin composition employs the compatibilizer prepared from PP-AA (or EPDM-MAH, PP-MAH) and NBR-EPOXY, the product of the thermoplastic resin composition exhibits improved mechanical strength (such as tensile strength or tear strength). Furthermore, since the thermoplastic resin composition does not include a compound having amine group, the product of the thermoplastic resin composition has good color performance and is odorless. In comparison with products made of the commercial PP and NBR composition (Geolast 701-70), the product of the thermoplastic resin composition of the disclosure also exhibits superior mechanical strength (such as tensile strength or tear strength).

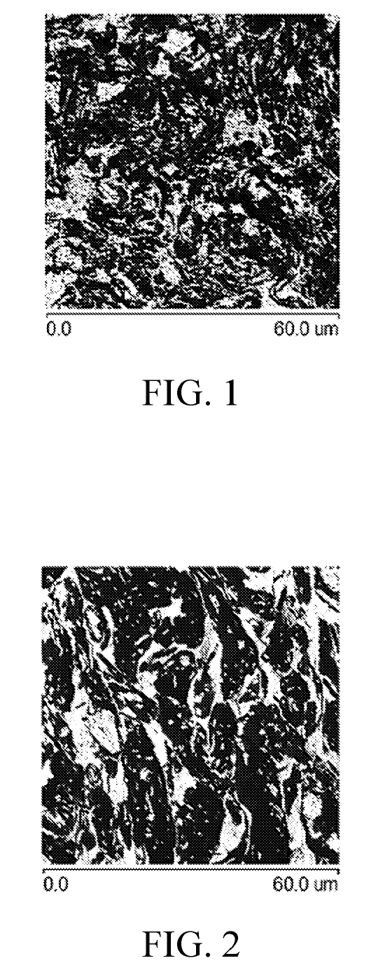

The test pieces of the Example 2 and Comparative Example 1 were observed by AFM (atomic force microscopy) to determine the compatibility of the polypropylene and nitrile-butadiene rubber, and the results show in FIGS. 1 and 2 (nitrile-butadiene rubber is represented by dark areas, and polypropylene is represented by light areas). As shown in FIGS. 1 and 2, the product of the thermoplastic resin composition provided by Example 2 has an improved dispersibility of polypropylene. This means that the product of the thermoplastic resin composition provided by Example 2 exhibits superior compatibility of nitrile-butadiene rubber and polypropylene.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A compatibilizer, comprising:
100 parts by weight of polyolefin having at least one reactive functional group; and
80-120 parts by weight of a copolymer, wherein the copolymer has x number of repeat units represented by 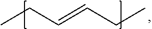
y number of repeat units represented by 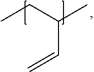
z number of repeat units represented by 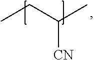
and at least one terminal group represented by 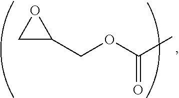
wherein x, y, and z are independently an integer larger than or equal to 1; and x/(x+y+z) is from 0.5 to 0.7, y/(x+y+z) is from 0.1 to 0.2, and z/(x+y+z) is from 0.1 and 0.4, and wherein the repeat unit represented by 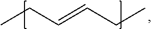
the repeat unit represented by 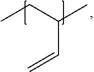
and the repeat unit represented by 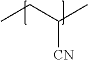
are arranged in a regular or random fashion.

2. The compatibilizer as claimed in claim 1, wherein the polyolefin having at least one reactive functional group is polypropylene having at least one reactive functional group, ethylene-propylene-diene copolymer (EPDM) having at least one reactive functional group, or a combination thereof.

3. The compatibilizer as claimed in claim 1, wherein the copolymer has two terminal groups represented by 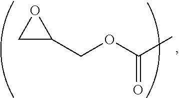
and 2/(x+y+z) is between 0.008 and 0.05.

4. The compatibilizer as claimed in claim 1, wherein the reactive functional group is 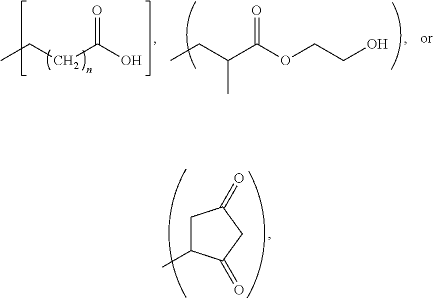
wherein n is an integer from 1 to 10.

5. The compatibilizer as claimed in claim 1, wherein the copolymer has a weight average molecular weight from 1,000 to 10,000.

6. The compatibilizer as claimed in claim 1, wherein the reactive functional group of the polyolefin having at least one reactive functional group has a weight percentage between 0.5 wt % and 5 wt %, based on the weight of the polyolefin having at least one reactive functional group.

7. A thermoplastic resin composition, comprising:
(a) 60-90 parts by weight of nitrile-butadiene rubber;
(b) 10-40 parts by weight of polyolefin;
(c) the compatibilizer as claimed in claim 1, wherein the compatibilizer has a weight percentage between 5 wt % and 15 wt %, based on the total weight of (a) nitrile-butadiene rubber and (b) polyolefin; and
(d) cross-linking agent, wherein the cross-linking agent has a weight percentage between 0.2 wt % and 2.0 wt %, based on the total weight of (a) nitrile-butadiene rubber and (b) polyolefin.

8. The thermoplastic resin composition as claimed in claim 7, wherein the (d) cross-linking agent is a peroxide cross-linking agent.

9. The thermoplastic resin composition as claimed in claim 8, wherein the peroxide cross-linking agent is benzoyl peroxide, 1,1-bis(tert-butylperoxy)cyclohexane, 2,5-bis(tert-butylperoxy)-2,5-dimethylcyclohexane, 2,5-bis(tert-butylperoxy)-2,5-dimethyl-3-cyclohexyne, bis(1-(tert-butylpeorxy)-1-methy-ethyl)benzene, tert-butyl hydroperoxide, tert-butyl peroxide, tert-butyl peroxybenzoate, cumene hydroperoxide, cyclohexanone peroxide, dicumyl peroxide, lauroyl peroxide, or a combination thereof.

10. The thermoplastic resin composition as claimed in claim 7, further comprising:
(e) inorganic powder, wherein the inorganic powder has a weight percentage between 1 wt % and 20 wt %, based on the total weight of (a) nitrile-butadiene rubber and (b) polyolefin.

11. The thermoplastic resin composition as claimed in claim 10, wherein the (e) inorganic powder is kaolin, silicon oxide, aluminum oxide, titanium oxide, zirconium oxide, aluminum hydroxide, magnesium hydroxide, or a combination thereof.

12. The thermoplastic resin composition as claimed in claim 7, further comprising:
(f) plasticizer, wherein the plasticizer has a weight percentage between 1 wt % and 40 wt %, based on the total weight of (a) nitrile-butadiene rubber and (b) polyolefin.

13. The thermoplastic resin composition as claimed in claim 12, wherein the (f) plasticizer is dibutyl phthalate, dioctyl phthalate, diisononyl phthalate, butyl benzyl phthalate, diisooctyl phthalate, dicyclohexyl phthalate, dibutyl adipate, dioctyl adipate, dibutyl sebacate, polypropylene glycol dibenzoate, 2-ethylhexyl diphenyl phosphate, t-butylphenyl diphenyl phosphate, trioctyl trimellitate, tri-2-ethylhexyl trimellitate, triisononyl trimellitate, isopropyl myristate, or a combination thereof.

14. The thermoplastic resin composition as claimed in claim 7, wherein the (b) polyolefin is polyethylene, polypropylene, polybutene, or a combination thereof.
